(19) United States
(12) Patent Application Publication
(10) Pub. No.: US 2004/0193460 A1
(43) Pub. Date: Sep. 30, 2004

(54) System and method for structuring contract performance terms

(76) Inventors: Jean-Francois Ducholet, Paris (FR); Claude J. Pivard, Paris (FR); Jean Becourt Foch, Paris (FR)

Correspondence Address: BURNS, DOANE, SWECKER & MATHIS, L.L.P., P.O. Box 1404, Alexandria, VA, 22313-1404, US

(21) Appl. No.: 10/400,516

(22) Filed: Mar. 28, 2003

(51) Int. Cl. G06F 17/60

(52) U.S. Cl. 705/7

(57) ABSTRACT

A system and method for determining an integrated and interlocking series of contractual terms to govern and manage the design, construction, lease, and operation of a manufacturing plant, with the contractual terms being automatically selected from an experience database of information gleaned from the actual construction and operation of similar manufacturing plants. The contractual terms are assembled into agreements between respective pairs of parties to the construction, purchase, lease, and operation of the plant, the parties being an engineering company, a bank, an operating company, and a consumer of the plant's product. The resultant product delivery, purchase, lease, and operating agreements provide for mutual obligations between the parties from the design through to the operation of the manufacturing plant. Following construction of the plant, embodiments of the system serve to monitor operation of the plant, providing exception reporting and recommendations how to optimize plant operation.

### BACKGROUND OF THE INVENTION

1. Field of the Invention

The present invention relates to methods for optimized operation of manufacturing plants and, more specifically, to an integrated system and method for determining contract and performance terms for managing the optimized construction and operation of a manufacturing plant wherein the builder, operator, owner, and user of the plant are separate entities linked together by contractual agreements.

2. Description of the Related Art

Within a vertical business, the primary raw materials required by the business to produce an end product are provided or manufactured by entities under the ownership of the business itself. For example, a tire manufacturing company that is vertically organized would own the source of the rubber, i.e., a rubber tree plantation; would own the rubber-producing plant; and would own the tire-molding plant. One advantage of such a business structure is that the tire-producing company need not incur the profit costs of each separate business involved in the production of a tire. Furthermore, each of the critical products and processes to produce a finished tire from rubber latex are under the control of the business. Finally, each part or entity within the vertical structure need not be profitable for the entire business to be profitable.

However, rarely is a single business an expert in each phase of turning a raw material into a final product. In the above example, the tire-producing company may be very effective designing and marketing tires for use by the consuming market, including vehicle manufacturers. But that same tire-producing company may know very little about cultivating rubber trees to maximize latex production and further may know very little about the actual, day-to-day operation of a tire-manufacturing plant. Therefore, notwithstanding the theoretical efficiencies of a vertical business structure, a vertical conglomerate may actually produce a tire at a higher cost than a series of independent companies, each producing a product utilized by the next company in the chain to produce a product until the final product is directed to the final consumer.

Additionally, an operating company may lack the capital to build the necessary plants to manufacture the materials and products required to produce the final product. Often, in order to obtain financing to build new manufacturing facilities, the operating company must grant concessions or pay additional fees to effectively indemnify the bank or venture capitalist that a loan or investment to construct a manufacturing plant will be paid back or recouped. Such requirements act to constrain the business of the operating company, either by imposing conditions on the operating company, such as a prohibition against engaging in purchase agreements with less than a predetermined profit margin, or by imposing additional costs on the operating company in the form of financing fees or interest payments.

Finally, contractual agreements between construction companies, banks, operating companies, and consumers regarding the construction and operation of manufacturing plants are often filled with boiler plate terms that have little relevance to the particular entities that are involved in the plant and are often complex, lengthy contracts that require many sessions of negotiations and drafts before a final agreement is produced for signature.

These and other drawbacks, problems, and limitations of conventional systems and methods for structuring contract performance terms are overcome according to exemplary embodiments of the present invention

### SUMMARY OF THE INVENTION

The present invention is directed toward a system and method for determining an integrated and interlocking series of contractual terms to govern and manage the design, construction, lease, and operation of a manufacturing plant, with the contractual terms being automatically selected from an experience database of information gleaned from the actual construction and operation of similar manufacturing plants. The contractual terms are assembled into agreements between respective pairs of parties to the construction, purchase, lease, and operation of the plant, the parties being an engineering company, a bank, an operating company, and a consumer of the plant's product. The resultant product delivery, purchase, lease, and operating agreements provide for mutual obligations between the parties from the design through to the operation of the manufacturing plant. Following construction of the plant, embodiments of the system serve to monitor operation of the plant, providing exception reporting and recommendations how to optimize plant operation. Exemplary embodiments of the inventive system implement a separation of roles, thereby permitting the parties to the various agreements both to utilize their particular expertise to optimize the contractual arrangement and subsequent management of the design, construction, lease, and operation of the plant and to take advantage of a wealth of recorded experience in the technology of the particular plant being built and operated. Similarly, while the contracts generated by the system provide for integrated design, construction, purchase, lease, and operation of the plant, they also provide for separating the investment in and the operation of the plant.

In accordance with one aspect of the present invention, a system and method are directed toward structuring contractual terms for the supply of a manufactured product, including acquiring contractual terms associated with the design, construction, lease, and operation of a manufacturing plant; determining contractual terms governing the design and construction of the manufacturing plant by an engineering company; determining contractual terms governing the lease of the manufacturing plant by a consumer; and determining contractual terms governing the operation of the manufacturing plant by an operating company for the production of a manufactured product, wherein the contractual terms governing the performances of the engineering company, the consumer, and the operating company are drawn from the acquired contractual terms.

In accordance with another aspect of the present invention, a system and method are directed toward optimizing the operation of a manufacturing plant, including acquiring manufacturing plant performance data; determining the terms of a first agreement for contracting with an engineering company to build a manufacturing plant; determining the terms of a second agreement for contracting with a consumer to lease the built manufacturing plant; and determining the terms of a third agreement for contracting with an operating company to operate the built manufacturing plant, wherein the terms of the first, second, and third agreements are determined from the acquired manufacturing plant performance data.

As a further feature of the present invention, the system acquires plant performance data from the operation of the built manufacturing plant; compares the acquired plant performance data with the acquired manufacturing plant performance data; outputs as exceptions those instances where the operation of the manufacturing plant is below an optimum operation level as determined by the acquired manufacturing plant performance data; and outputs as recommendations, changes to bring the plant back into compliance with the optimum operation level.

In accordance with yet another aspect of the present invention, a system and method are directed toward managing contracted service performances, including acquiring manufacturing plant performance data; drafting a first agreement establishing contract terms between a bank and an engineering company for building a manufacturing plant according to the terms of the first agreement; drafting a second agreement establishing contract terms between the bank and a consumer to lease the built manufacturing plant according to the terms of the second agreement; and drafting a third agreement establishing contract terms between the consumer and an operating company to operate the built manufacturing plant according to the terns of the third agreement, wherein the terms of the first, second, and third agreements are automatically determined from the acquired manufacturing plant performance data.

### BRIEF DESCRIPTION OF THE DRAWINGS

These and other objects and advantages of the present invention will become more apparent and more readily appreciated from the following description of the preferred embodiments, taken in conjunction with the accompanying drawings, wherein like reference numerals have been used to designate like elements, and wherein:

FIG. 1 shows a diagram of the contracting parties whose performances are managed under terms of agreements developed by preferred embodiments of the invention;

FIG. 2 shows a component diagram of the resources comprising a preferred embodiment of the invention;

FIG. 3 shows a component and services flow chart of an alternative embodiment for determining contract service terms;

FIG. 4 shows a flow chart of an exemplary system for determining contract service terms; and

FIG. 5 shows a component and services flow chart of an alternative embodiment for determining contract service terms.

### DETAILED DESCRIPTION OF THE PREFERRED EMBODIMENTS

In the following description, for purposes of explanation and not limitation, specific details are set forth in order to provide a thorough understanding of the present invention. However, it will be apparent to one skilled in the art that the present invention may be practiced in other embodiments that depart from these specific details. In other instances, detailed descriptions of well-known methods, devices, and data structures are omitted so as not to obscure the description of the present invention.

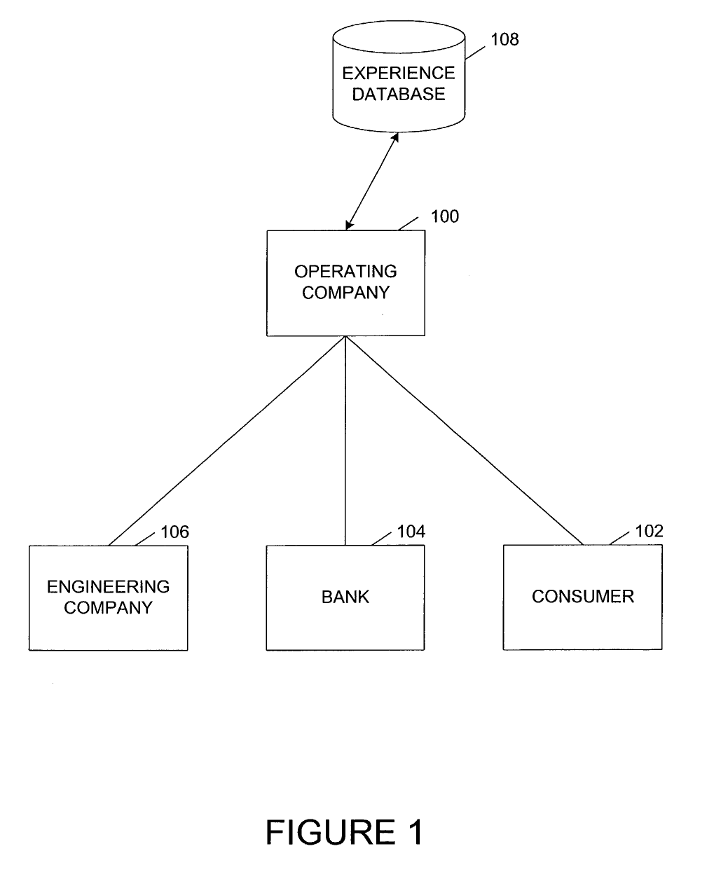

Referring initially to FIG. 1, there is illustrated a diagram of the entities comprising the contracting parties that can utilize exemplary embodiments of the invention to establish their respective contractual positions, obligations, and benefits. The term entity is utilized within the present inventive system to typically represent a business with a least one physical facility where the entity conducts business and where multiple persons are employed. However, an individual can be a contracting party within the meaning and scope of the present invention without detracting from the features available under exemplary embodiments of the invention. Additionally, embodiments of the invention can be utilized by individuals and companies which lack any physical facilities or employees.

The performances of each of these contracting parties can be guided by terms of agreements developed by embodiments of the invention. The present invention is couched in the environment of manufacturing facilities wherein a consumer of a manufactured product is another entity rather than an individual consumer. In the environment of industrial gases, for example, a manufacturing plant can produce cryogenic gases in the form of liquid nitrogen or liquid carbon dioxide. One typical consumer 102 of these industrial gases can be the manufacturer of cryogenic freezing and processing equipment, such as for flash-freezing food products. Alternatively, the consumer 102 of cryogenic gases can be a service business that leases, operates, and maintains the cryogenic equipment on a customer's site or sites. In either circumstance, the consumer 102 can be a business with a critical need for a reliable source for large volumes of industrial gases. However, as discussed above, the consumer 102 can lack the resources to build its own manufacturing plant and can further lack the expertise to operate the manufacturing plant as efficiently as possible.

Two key elements in this system are the operating company 100 and the experience database 108 of manufacturing plant operating parameters and contract terms. During the day-to-day operation of a manufacturing plant, literally thousands of pieces of information can be gathered and stored. Within the scope of exemplary embodiments of the present invention, an operating company 100 with experience operating one or more manufacturing plants can capture information ranging from operating parameters of each piece of equipment that comprises the manufacturing plant and its processes to the daily weather conditions that may affect the plant operation. Additional production information can include the volume of raw materials consumed during each period, such as a day or a week; the source and the cost of the raw materials; the volume of product produced during each such corresponding period; the specifications and quality requirements for both the raw materials and the finished products; the number of type of workers involved in each production process; and the contractual terms of purchase agreements, lease agreements, sale agreements, and operating agreements negotiated by or on behalf of the manufacturing plant. Additional information can be gleaned from other companies' operations, trade journals, news reports, and the like and added to the experience database 108. The experience database 108 can also be viewed as an incident database because it can hold information related to plant and equipment breakdowns and failures, thereby providing the present system with information associated with events to be avoided during the optimum design, construction, and operation of the plant. While the experience database 108 is represented in FIG. 1 as a single database, it can consist of a plurality of separate files and databases without detracting from the novel features of the present invention.

The operating company 100 can utilize embodiments of the present invention to develop and structure various operating agreements involved in the design, building, purchase, leasing, and operating of various manufacturing plants. This process begins with the building of the experience database 108 with information gleaned from the day-to-day operation of a wide variety of manufacturing plants, including information associated with the design, construction, and financing of such plants. While a particular operating company 100 can limit its expertise and application of the present invention to a particular product line or a limited geographic portion of the world, the inventive system and method described herein can be equally applicable to any manufacturing plant anywhere that acquires raw or manufactured materials and processes them into an output product available for purchase and consumption by a consumer, whether the consumer is an end user or, instead, utilizes the manufactured product as an input material in its own manufacturing plant.

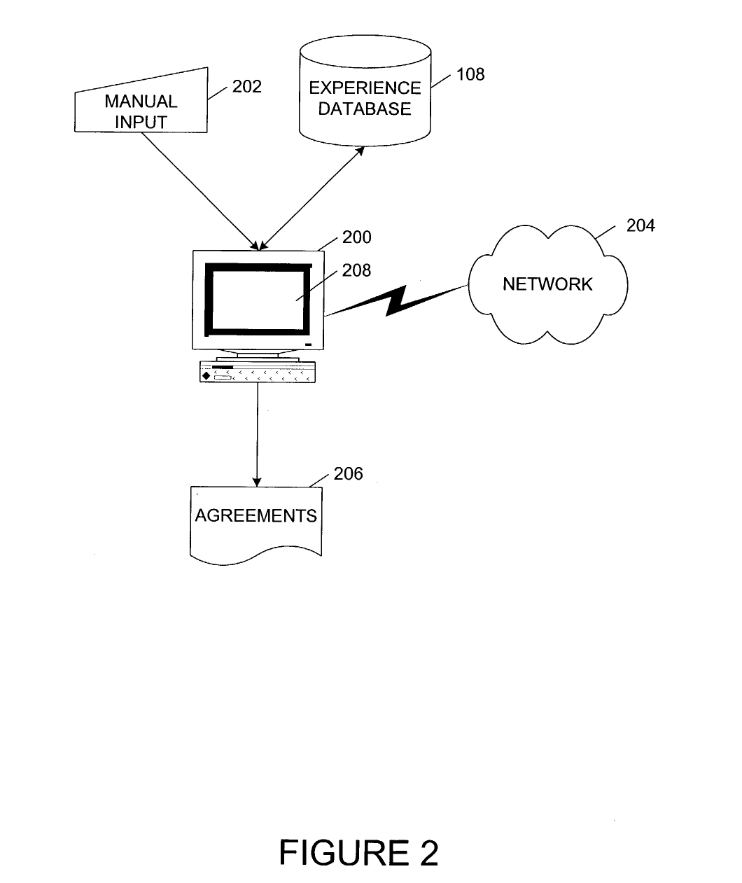

Referring briefly to FIG. 2, there are shown exemplary components that comprise the inventive system. The processing accomplished by the present invention is provided through a computer 200 which has access to the experience database 108. The computer 200 includes at least one computer readable medium that is encoded with software for effecting the processing associated with the structuring and selection of contractual terms for defining the relative responsibilities among the parties discussed above with reference to FIG. 1. The information stored on the experience database 108 can be input, in some instances, manually through at least one input device 202. Alternatively, the computer and/or the experience database 108 can be connected to a network 204, including the Internet, across which plant operating and experience data can be transmitted for storage on the experience database 108. This information can be manually provided or can be transmitted directly from various sensors and equipment (not shown) located in and around various manufacturing plants. One or more output devices 206 can print (or transmit across the network 204 to other users and devices of the inventive system) the terms, agreements, and operating parameters generated by the system. Additionally, the output from the inventive system can be displayed to the user through a graphical user interface 208. Although not required by exemplary embodiments of the present invention, the resources shown in FIG. 2 can be operated by the operating company 100, as more thoroughly discussed below.

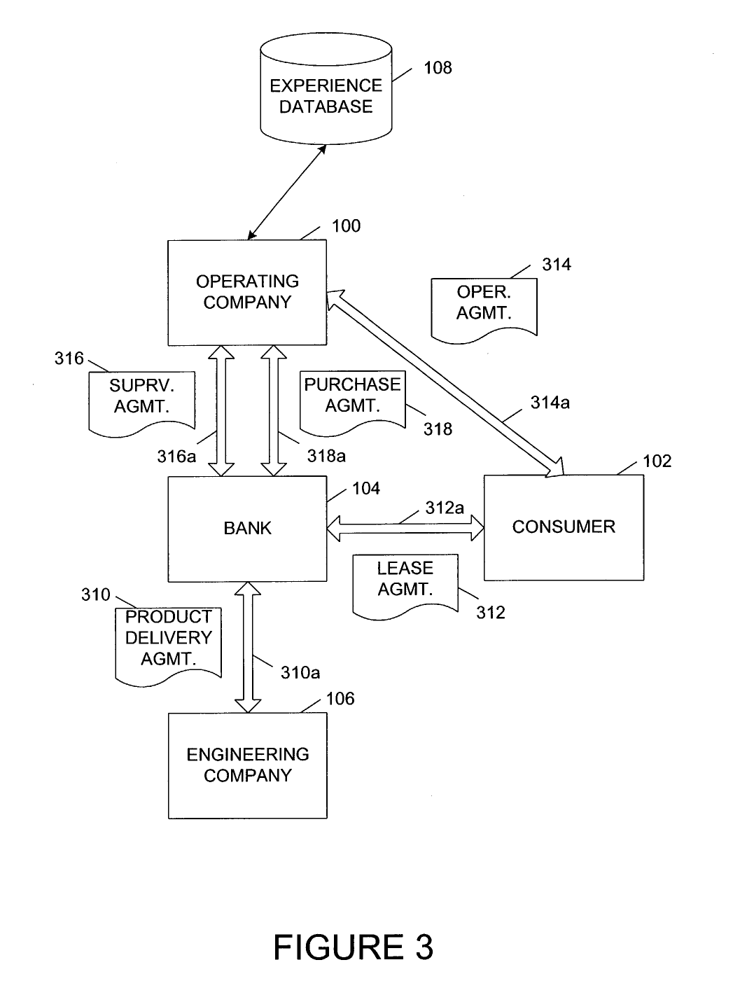

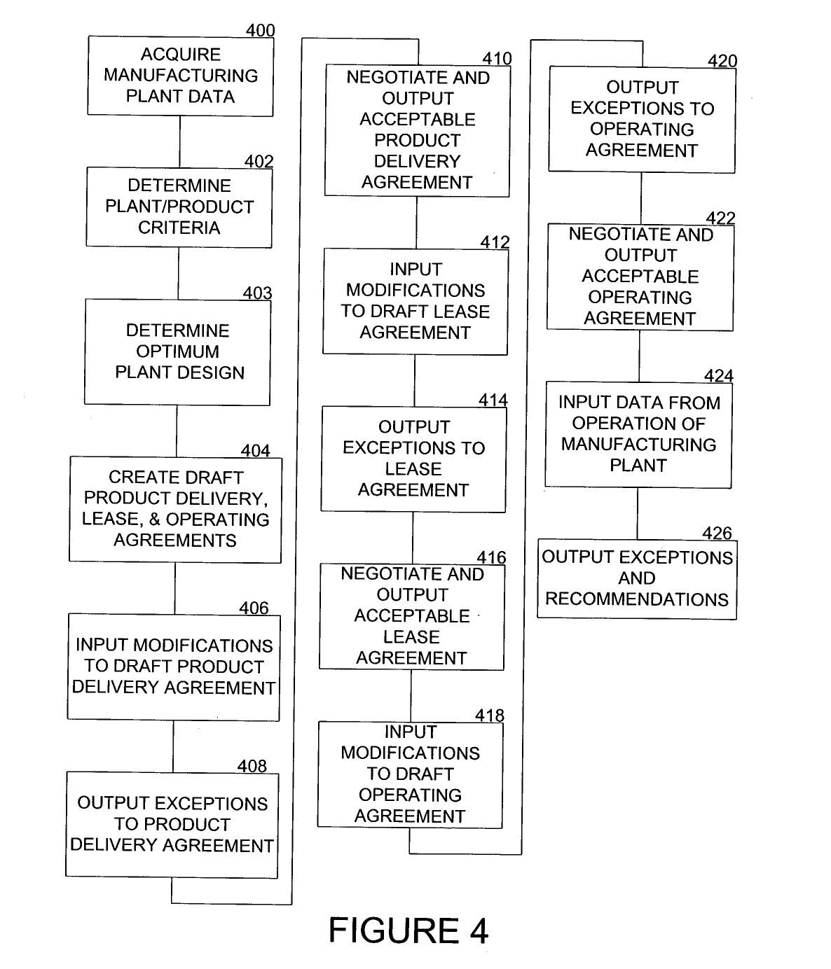

Referring now to FIGS. 3 and 4, the development of the contract terms for each agreement and the management of the performances of the contracting parties under the agreements will be discussed. Initially, at step 400, the operating company 100 acquires data related to the day-to-day operation of one or more manufacturing plants and stores it in an experience database 108. The operating company 100 approaches a consumer 102 and proposes the design, construction, and operation of a manufacturing plant for the production of a particular product, such as the cryogenic gas, liquid nitrogen. The operating company 100 has expertise in the design and operation of the subject manufacturing plant and has available to it the experience database 108 of information, parameters, and contract terms related to the design, construction, purchase, lease, and operation of comparable manufacturing plants. Alternatively, the operating company 100 can rely on the experience of an engineering company 106 to provide the expertise and information regarding the design and/or the construction of the proposed manufacturing plant. As used herein, the engineering company can have the ability to design, build, manufacture, and/or assemble a manufacturing plant. Additionally, the engineering company can have the expertise to also operate the plant.

The consumer 102 is a known or potential consumer of the intended manufactured product, a product with which the operating company 100 has production experience. During the meeting of the operating company 100 and the consumer 102 at step 402, details of the potential manufacturing plant are discussed. These detailed plant and operating criteria include the product(s) to be produced, the range of output product(s) desired or anticipated, and the financial resources of the consumer 102. This information is input to embodiments of the present invention, with the first output being one or more designs for the proposed manufacturing plant, with the optimum design noted by the system at step 403 as most closely matching the proposed criteria of the plant and the resources of the consumer 102.

Upon selection of the desired plant design by the consumer 102, the system at step 404 then produces a draft product delivery agreement 310, a draft lease agreement 312, and a draft operating agreement 314. Alternatively, the operating company 100 can select the desired plant design based on information provided by the consumer 102 and the optimum design recommended by the system at step 403. Those familiar with the delivery of manufacturing plants and the manufacture of products can appreciate that the product delivery agreement 310 is also known as a “product supply agreement” and is distinguishable from agreements to deliver and/or supply to a consumer the actual product manufactured or produced by the plant. The terms that comprise each of the agreements created by the system are selected from the information stored on the experience database 108 based on input criteria, parameters, and/or terms input by the operating company 100 and/or the consumer 102. The system can also produce a list of engineering companies 106 who have the expertise to construct the proposed manufacturing plant. The engineering companies 106 are ranked according to the information in the experience database 108, with those engineering companies who have constructed similar manufacturing plants within budget and on time receiving the highest ranking.

Additionally, a list of banks 104 can be generated by the system based on the magnitude of the plant selected and the financial resources and credit ranking of the consumer 102. The banks 104 are ranked within the list, with banks with lower interest rates, experience with construction loans and real property lease agreements, and branches near the site of the proposed plant being assigned the highest ranking by the system. As used herein, the term, “bank,” can apply to any entity, including an individual, that is willing and able to provide funding for the construction of the plant and is not limited to financial institutions chartered and/or licensed to provide banking services. Through meetings among the operating company 100, the consumer 102, the banks 104, and the engineering companies 106, a bank 104 and an engineering company 106 are selected to complete the quadrant of four entities who will be contractually tied together by the product delivery agreement 310, the lease agreement 312, and the operating agreement 314.

The draft product delivery agreement 310 is presented to the engineering company 106 and the bank 104 for their approval. While termed a product delivery agreement 310, the agreement 310 can also be termed a construction agreement in that it can include the design and construction criteria and specifications for the construction of the manufacturing plant. It is against these design and construction criteria and specifications that the construction and ultimate completion of the manufacturing plant can be compared to determine whether delivery of the completed plant to the bank 104 should be accepted. If any modifications are proposed to the draft product delivery agreement 310, these changes are input to the system at step 406; and a second product delivery agreement 310 is produced at step 408, within the limits imposed by the system, the operating company 100, and the consumer 102. For example, if the consumer 102 has indicated that the plant must be operational within one year of ground-breaking, and the engineering company 106 has proposed changing this term of the product delivery agreement 310 to a fourteen month delivery, this difference will be detected by the system and noted as an exception to be resolved before a final draft of the product delivery agreement 310 will be output by the system. Once all exceptions are resolved among the contracting parties, the changes are input to the present inventive system, and a final product delivery agreement 310 is produced at step 410. The final product delivery agreement 310 includes the selected design for the plant, all building specifications and blueprints, and construction time tables.

Additionally, since the bank 104 has been enlisted, and has agreed, to finance the construction, a scheduled list of payments from the bank 104 to the engineering company 106 can be included in the product delivery agreement 310 along with a corresponding list of construction performances which must be met before the payments are to be tendered. The final product delivery agreement 310 produced by the system is presented to the bank 104 and the engineering company 106 for signature by their authorized representatives and becomes the contractual map by which the manufacturing plant is to be constructed by the engineering company 106 and by which the engineering company 106 is to be paid by the bank 104. Because the final product delivery agreement 310 is produced by the inventive system based on input parameters and criteria established by the operating company 100 and the consumer 102, both parties can be assured that the contractual terms and construction criteria and standards by which the engineering company 106 will build the plant are satisfactory to the operating company 100 who will eventually operate the plant and satisfactory to the consumer 102 who will lease the plant from the bank 104 and rely on it to produce a required output product. Additionally, an exemplary embodiment of the system can generate, at step 404, a construction supervision agreement 316 that includes contractual clauses defining the role and responsibilities of the operating company 100 as a construction or supervising engineer for the bank 104 during the construction of the manufacturing plant to ensure the plant is built in accordance with the design specifications.

The determination of the location for the plant and the purchase or lease of the land upon which the plant will be constructed are typically the responsibility and the authority of the consumer 102. In the alternative, the bank can acquire the desired tract of land and include the cost of the land purchase in the lease agreement 312. In either event, any design and construction criteria that are a function of the location of the plant can be input to the system to customize the product delivery agreement 310 accordingly. For example, the plant site may require additional grading, deeper footings, or a longer access drive, each of which can be reflected in the final design and construction terms of the product delivery agreement 310.

The draft lease agreement 312 is presented to the consumer 102 and the bank 104 for their approval. If any modifications are proposed to the draft lease agreement 312, these changes are input to the system at step 412; and a second lease agreement 312 is produced at step 414, within the limits imposed by the system, the operating company 100, and the consumer 102. For example, if the consumer 102 has indicated that it cannot afford a monthly lease cost in excess of $125,000, and the bank 104 has proposed a monthly lease cost of $150,000, this difference will be detected by the system and noted as an exception to be resolved before a final draft of the lease agreement 312 will be output by the system. Once all exceptions are resolved among the contracting parties, the changes are input to an exemplary embodiment of the present inventive system, and a final lease agreement 312 is produced at step 416. The final lease agreement 312 includes, for example, interest rate terms, monthly costs, insurance requirements, monthly payment due dates, late payment penalties, and default provisions. The final lease agreement 312 produced by the system is presented to the bank 104 and the consumer 102 for signature by their authorized representatives and becomes the contractual map by which the manufacturing plant is to be leased from its owner, the bank 104, and by which the bank 104 is to be paid by the consumer 102.

Because the final lease agreement 312 is produced by an embodiment of the inventive system based on input parameters and criteria established by the operating company 100 and the consumer 102, both parties can be assured that the contractual and financial terms by which the consumer 102 will lease the manufacturing plant from the bank 104 are satisfactory to the consumer 102 who will lease the plant from the bank 104 and rely on it to produce a required output product. Additionally, because the operation of the plant will be under terms drawn from the experience database 108, as discussed more thoroughly below, the risk borne by the bank 104 that the plant may fail are lessened; and the bank 104 can require less compensation through lease payments to cover the cost of the risk of failure. Finally, if elected by the operating company 100 and the bank 104, the system can generate at step 404 a buy-out agreement 318 specifying buy-out terms whereby the operating company 100 can purchase the plant from the bank 104 during or at the completion of the lease agreement 312. Through the terms and the operation of the buy-out agreement 318, any risk to the bank 104 regarding plant operating and maintenance costs can be lessened by providing terms and specifying predetermined events whereby the purchase of the plant by the operating company 100 is triggered, including the failure of the consumer 102 to maintain lease payments.

The draft operating agreement 314 is presented to the operating company 100 and the consumer 102 for their approval. If any modifications are proposed to the draft operating agreement 314, these changes are input to the system at step 418; and a second operating agreement 314 is produced at step 420, within the limits imposed by the system, the operating company 100, and the consumer 102. For example, if the consumer 102 has indicated that the plant must be able of producing 1,000 cubic feet of liquid nitrogen per day, and the operating company 100 has proposed changing this term of the operating agreement 314 to producing 750 cubic feet daily, this difference will be detected by the system and noted as an exception to be resolved before a final draft of the operating agreement 314 will be output by the system at step 422. In this manner, the interests of all parties are protected, even in an environment where the present inventive system is being utilized by the operating company 100 to define the criteria by which the manufacturing plant will be designed, built, leased, and operated. Once all exceptions are resolved among the contracting parties, the changes are input to the present inventive system, and a final operating agreement 314 is produced. The final operating agreement 314 can specify optimum settings for all equipment in the plant, including marginal operating ranges given variables agreed upon by the operating company 100 and the consumer 102. These variables can include daily production volume, guaranteed up time for the plant, and quality of the output product(s). Typically, the term of the operating agreement 314 can be set to the same length as the duration term of the lease agreement 312. The arrows 310a, 312a, 314a, 316a, and 318a represent the mutual obligations specified by the terms of the respective product delivery, lease, operating, supervision, and purchase agreements as determined, drafted, and output by exemplary embodiments of the inventive system.

One advantage of the present invention is that manufacturing plant experience, including equipment operating parameters, has been stored on the experience database 108. With this information, the present system has the information to establish proven operating parameters for a complex combination of operating equipment, thereby enabling the operating company 100 to optimize plant operation and guarantee an attainable up time percentage and, correspondingly, assure the consumer 102 that the operating company 100 and the manufacturing plant will be able to produce a desired/contracted volume and quality of the desired product. With such assurances, the consumer 102 is better prepared to plan on the availability of a known quantity of product. The final operating agreement 314 produced by the system is presented to the operating company 100 and the consumer 102 for signature by their authorized representatives and becomes the contractual map by which the manufacturing plant is to be operated by the operating company 100 and by which the manufactured products are to be timely produced for the consumer 102.

Because the final operating agreement 314 is produced by the inventive system based on input parameters and criteria established by the operating company 100 and the consumer 102, both parties can be assured that the contractual terms, plant operating criteria, and product standards are satisfactory to the operating company 100 who will operate the plant and satisfactory to the consumer 102 who will rely on the plant to produce a required output product. For example, the consumer 102 specifying a requirement that the plant operate 98% of the time can trigger embodiments of the invention to generate such operational requirements, for example, that double compressors will be required, that two shifts of personnel at particular positions will be necessary, and that an additional $10,000 in monthly operating fees will need to be paid to the operating company 100.

Additionally, during plant operation, information from the day-to-day operations are added to the experience database 108 at step 424, and reports are generated comparing the plant's operation with the operation of comparable plants. Any differences in the plant's operation as compared to past operations and as compared to an optimum operation are highlighted as exceptions in the reports or on a display available to the user of the inventive system; and recommendations are made at step 426 regarding equipment settings, process flow, personnel allocation, raw materials acquisition, etc. to improve and optimize the plant's operation. Since the present inventive system is thereby assisting the operating company 100 with the day-to-day operation and management of the plant, the operating company 100 experiences cost savings and risk reduction over having to provide this overview and management itself, thereby increasing any profit to the operating company 100 and reducing the operating fees payable by the consumer 102.

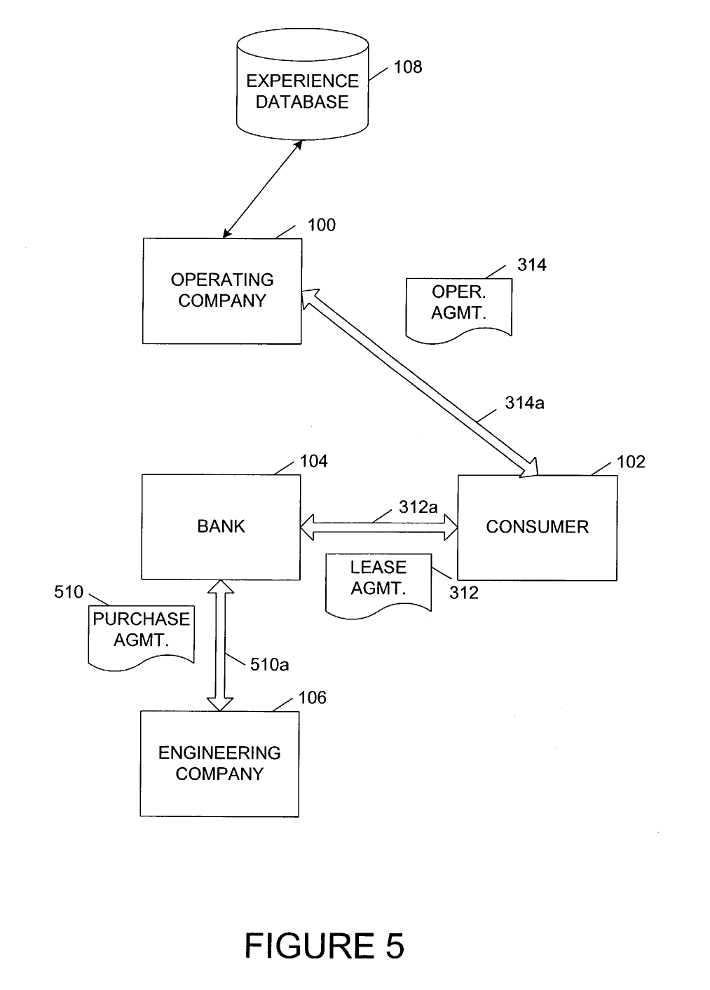

Referring now to FIG. 5, there is shown an alternative embodiment of the present invention. In this version, the product delivery agreement of FIG. 3 is replaced with a purchase agreement 510. The purchase agreement 510 is developed by the system in the same manner as the product delivery agreement 310 of FIG. 3 and also includes contract terms regarding plant design, construction criteria, and delivery deadlines. However, the financing aspect of the plant construction differs in the embodiment represented by FIG. 3 in that the engineering company 106 finances the construction of the plant, either directly or through third party financing. The purchase agreement 510 provides terms for the required and scheduled sale of the completed plant by the engineering company 106 to the bank 104 and the corresponding obligatory purchase of the plant by the bank 104 from the engineering company 106. The purchase terms can include, as a condition precedent for the final payment from the bank 104 to the engineering company 106, delivery of an affidavit from the operating company 100 that the constructed plant is satisfactorily operational. In this embodiment, the engineering company 106 bears the burden of financing the construction of the manufacturing plant. Such an option provides additional flexibility for the integrated design, construction, financing, and operation facilitated and managed by the present system by transferring the financial burden away from the bank 104 in those circumstances and in those economic regions where the banks 104 are either unable or unwilling to finance a construction project or will do so only at undesirably high interest rates or fees. In such an environment, the engineering company 106 may be willing to assume the financing risk and burden of designing and constructing the plant, with contractual assurances through the predetermined purchase agreement 510 that a willing and able buyer, the bank 104, is obligated to purchase the completed plant. Alternatively, the embodiment shown in FIG. 5 can also include a purchase agreement between the bank 104 and the operating company 100 for the subsequent purchase of the completed plant in a manner similar to the flow shown in FIG. 3. Similar to the flow shown in FIG. 3, the arrows 312a, 314a, and 510a represent the mutual obligations specified by the terms of the respective lease, operating, and purchase agreements as determined and drafted by exemplary embodiments of the inventive system.

Although preferred embodiments of the present invention have been shown and described, it will be appreciated by those skilled in the art that changes may be made in these embodiments without departing from the principle and spirit of the invention, the scope of which is defined in the appended claims and their equivalents.

What is claimed is:

1. A method for structuring contractual terms for the supply of a manufactured product, comprising:
acquiring contractual terms associated with the design, construction, lease, and operation of a manufacturing plant;
determining contractual terms governing the design and construction of the manufacturing plant by an engineering company;
determining contractual terms governing the lease of the manufacturing plant by a consumer; and
determining contractual terms governing the operation of the manufacturing plant by an operating company for the production of a manufactured product,
wherein the contractual terms governing the performances of the engineering company, the consumer, and the operating company are drawn from the acquired contractual terms.

2. The method according to claim 1, wherein the acquired contractual terms are stored in an experience database for access to facilitate the optimum operation of the manufacturing plant.

3. The method according to claim 1, wherein the determined contractual terms governing the design and construction of the manufacturing plant are assembled and output as an agreement determining contractual performance by the engineering company.

4. The method according to claim 1, wherein the determined contractual terms governing the lease of the manufacturing plant are assembled and output as an agreement determining contractual performance by the consumer.

5. The method according to claim 1, wherein the determined contractual terms governing the operation of the manufacturing plant are assembled and output as an agreement determining contractual performance by the operating company.

6. The method according to claim 1, wherein the contractual terms governing the operation of the manufacturing plant include plant operating standards and procedures.

7. The method according to claim 1, wherein the contractual terms governing the operation of the manufacturing plant include contractual terms imposed on the consumer to purchase the output of the manufacturing plant.

8. The method according to claim 1, wherein the lease contractual terms govern the lease of the manufacturing plant by the consumer from a bank.

9. The method according to claim 8, including determining contractual terms governing the purchase of the manufacturing plant from the bank by the operating company upon the occurrence of a predetermined event.

10. A method for optimizing the operation of a manufacturing plant, comprising:
acquiring manufacturing plant performance data;
determining the terms of a first agreement for contracting with an engineering company to build a manufacturing plant;
determining the terms of a second agreement for contracting with a consumer to lease the built manufacturing plant; and
determining the terms of a third agreement for contracting with an operating company to operate the built manufacturing plant,
wherein the terms of the first, second, and third agreements are determined from the acquired manufacturing plant performance data.

11. The method according to claim 10, wherein the third agreement includes contract terms requiring the consumer to purchase the output of the manufacturing plant.

12. The method according to claim 10, wherein the second agreement includes contractual terms governing the lease of the manufacturing plant by the consumer from a bank.

13. The method according to claim 12, including determining the terms of a fourth agreement for contracting with the operating company to purchase the manufacturing plant from the bank, wherein the fourth agreement includes contractual terms imposing an obligation upon the operating company to purchase the manufacturing plant upon occurrence of a predetermined event.

14. The method according to claim 13, wherein the predetermined event includes the termination of a lease between the consumer and the bank.

15. The method according to claim 13, wherein the first agreement comprises a product delivery agreement, the second agreement comprises a lease agreement, the third agreement comprises an operating agreement, and the fourth agreement comprises a purchase agreement.

16. The method according to claim 10, wherein the acquired manufacturing plant performance data includes equipment operating parameters, volume of raw materials consumed, volume of products produced, number of personnel working, quality requirements for raw materials, quality requirements for output products, and contract terms of purchase agreements, lease agreements, and operating agreements.

17. The method according to claim 16, further comprising:
acquiring plant performance data from the operation of the built manufacturing plant;
comparing the acquired plant performance data with the acquired manufacturing plant performance data;
outputting as exceptions those instances where the operation of the manufacturing plant is below an optimum operation level as determined by the acquired manufacturing plant performance data; and
outputting as recommendations, changes to bring the plant back into compliance with the optimum operation level.

18. A method for managing contracted service performances, comprising:
acquiring manufacturing plant performance data;
drafting a first agreement establishing contract terms between a bank and an engineering company for building a manufacturing plant according to the terms of the first agreement;
drafting a second agreement establishing contract terms between the bank and a consumer to lease the built manufacturing plant according to the terms of the second agreement; and
drafting a third agreement establishing contract terms between the consumer and an operating company to operate the built manufacturing plant according to the terms of the third agreement,
wherein the terms of the first, second, and third agreements are automatically determined from the acquired manufacturing plant performance data.

19. The method according to claim 18, wherein the first agreement comprises a product delivery agreement imposing a requirement on the engineering company to design, build, and deliver a manufacturing plant to the bank.

20. The method according to claim 19, wherein the first agreement further comprises a product delivery agreement imposing a requirement on the bank to deliver funding to the engineering company for the performance of contracted services by the engineering company.

21. The method according to claim 20, wherein the terms of the first agreement terminate upon delivery of the completed manufacturing plant to the bank and the delivery of payment in full to the engineering company, as long as the mutual deliveries are satisfactory to the bank and the engineering company.

22. The method according to claim 18, wherein the first agreement comprises a purchase agreement imposing a requirement on the bank to purchase the manufacturing plant built by the engineering company and imposing a requirement on the engineering company to sell the manufacturing plant.

23. The method according to claim 18, wherein the second agreement comprises a lease agreement imposing a requirement on the consumer to make regular payments to the bank for the duration of the second agreement.

24. The method according to claim 18, wherein the third agreement comprises an operating agreement imposing a requirement on the operating company to operate the manufacturing plant according to parameters drawn from the acquired manufacturing plant performance data for the duration of the third agreement.

25. The method according to claim 24, wherein the acquired manufacturing plant performance data includes equipment operating parameters, volume of raw materials consumed, volume of products produced, number of personnel working, quality requirements for raw materials, quality requirements for output products, and contract terms of purchase agreements, lease agreements, and operating agreements.

26. The method according to claim 24, wherein the third agreement includes contractual terms governing the operation of the manufacturing plant according to specific operating standards and procedures.

27. The method according to claim 26, further comprising:
acquiring plant performance data from the operation of the manufacturing plant;
comparing the acquired plant performance data with the acquired manufacturing plant performance data;
outputting as exceptions those instances where the operation of the manufacturing plant is below the specific operating standards; and
outputting as recommendations, changes to bring the plant back into compliance with the specific operating standards.

28. The method according to claim 26, wherein the third agreement includes warranty terms regarding the reliable operation of the manufacturing plant by the operating company.

29. The method according to claim 18, wherein the third agreement includes contract terms imposing a requirement on the consumer to make regular payments to the operating company for the duration of the third agreement and further imposes a requirement on the consumer to purchase the product manufactured by the plant.

30. The method according to claim 29, wherein the duration of the second agreement and the duration of the third agreement are the same.

31. The method according to claim 18, including drafting a fourth agreement establishing contractual terms between the bank and the operating company to purchase the manufacturing plant by the operating company according to the terms of the fourth agreement, wherein the fourth agreement includes contractual terms imposing an obligation upon the operating company to purchase the manufacturing plant from the bank upon occurrence of a predetermined event.

32. The method according to claim 31, wherein the predetermined event includes the termination of a lease between the bank and the consumer.

33. A system for structuring contractual terms for the supply of a manufactured product, comprising:
a storage device acquiring contractual terms associated with the design, construction, lease, and operation of a manufacturing plant;
a first processor determining contractual terms governing the design and construction of the manufacturing plant by an engineering company;
a second processor determining contractual terms governing the lease of the manufacturing plant by a consumer; and
a third processor determining contractual terms governing the operation of the manufacturing plant by an operating company for the production of a manufactured product,
wherein the contractual terms governing the performances of the engineering company, the consumer, and the operating company are drawn from the acquired contractual terms on the storage device.

34. A system for managing the operation of a manufacturing plant, comprising:
a storage device acquiring manufacturing plant performance data;
a first processor selecting the terms of a first agreement governing the building of a manufacturing plant by an engineering company;
a second processor selecting the terms of a second agreement governing the leasing of the built manufacturing plant by a consumer; and
a third processor selecting the terms of a third agreement governing the operating of the built manufacturing plant by an operating company,
wherein the terms of the first, second, and third agreements are determined from the acquired manufacturing plant performance data on the storage device.

35. A system for managing contracted service performances, comprising:
a storage device acquiring manufacturing plant performance data;
a first processor drafting a first agreement establishing contract terms between a bank and an engineering company for building a manufacturing plant according to the terms of the first agreement;
a second processor drafting a second agreement establishing contract terms between the bank and a consumer for leasing the built manufacturing plant according to the terms of the second agreement; and
a third processor drafting a third agreement establishing contract terms between the consumer and an operating company for operating the built manufacturing plant according to the terms of the third agreement,
wherein the terms of the first, second, and third agreements are automatically determined from the acquired manufacturing plant performance data on the storage device.

36. A computer readable medium encoded with software for determining contract performance terms by acquiring manufacturing plant performance data; determining the terms of a first agreement for contracting with a engineering company to build a manufacturing plant; determining the terms of a second agreement for contracting with a consumer to lease the built manufacturing plant; and determining the terms of a third agreement for contracting with an operating company to operate the built manufacturing plant, wherein the terms of the first, second, and third agreements are determined from the acquired manufacturing plant performance data.

37. A method for structuring contractual terms for the supply of a manufactured product, comprising:
acquiring contractual terms associated with the design, construction, lease, and operation of a manufacturing plant;
determining contractual terms governing the construction of the manufacturing plant by an engineering company;
determining contractual terms governing the purchase of the constructed manufacturing plant by a bank;
determining contractual terms governing the lease of the manufacturing plant by a consumer; and
determining contractual terms governing the operation of the manufacturing plant by an operating company for the production of a manufactured product,
wherein the contractual terms governing the performances of the engineering company, the bank, the consumer, and the operating company are drawn from the acquired contractual terms.
